(19) United States
(12) Patent Application Publication
(10) Pub. No.: US 2006/0097433 A1
(43) Pub. Date: May 11, 2006

(54) Process for the production of a plastic film

(76) Inventors: Walter Guenter, Forchheim (DE); Tobias Walcher, Forchheim (DE); Christian Hermann, Forchheim (DE)

Correspondence Address: JORDAN AND HAMBURG LLP, 122 EAST 42ND STREET, SUITE 4000, NEW YORK, NY, 10168, US

(21) Appl. No.: 10/545,339

(22) PCT Filed: Feb. 3, 2004
(86) PCT No.: PCT/EP04/00962

§ 371 Date: Oct. 14, 2005

(30) Foreign Application Priority Data
Feb. 11, 2003 (DE) 103 05 740.4

(51) Int. Cl. B29C 55/28

(52) U.S. Cl. 264/564

(57) ABSTRACT

Process for the production of an oriented plastic film from polyolefins and/or combinations of polyolefins and polyamide, which are manufactured by the extrusion and/or coextrusion blown film process, where an initial orientation operation is carried out biaxially during the blown film process, which is followed by another orientation operation.

The invention relates to a process for the production of an oriented plastic film from polyolefins and/or combinations of polyolefins and polyamide, which are manufactured by the extrusion and/or coextrusion blown film process.

The blown film process has proved to be a very successful way to manufacture plastic films.

The purpose of the invention is make further improvements to this process.

In the solution to this problem proposed by the invention, an initial orientation operation is carried out biaxially during the blown film process, which is followed by another orientation operation.

This makes further improvements to the properties of the films manufactured by the blown film process in an efficient way.

In another advantageous further development of the process in accordance with the invention, the second orientation operation is carried out directly after the first orientation operation.

It is, however, also possible in accordance with the invention if the second orientation operation is carried out independently of the first orientation operation.

It has proved to be very successful in this context if in accordance with the process proposed by the invention at least the first orientation operation is carried out biaxially at the same time.

In many cases, monaxial orientation is adequate for the second orientation operation, but further improvements can be made to the films with a second biaxial orientation operation.

In another very advantageous further development of the invention, the temperature of the blown film for orientation is set to be 90 to 180° C. depending on the plastic material used for production.

This is achieved at the end of the blowing operation primarily by means of cooling fans.

It is possible in accordance with the invention for temperature conditioning rollers to be used to carry out temperature conditioning of the film before the second orientation operation, which make sure the film temperature is about 100 to 180° C. If the film has already cooled down considerably, it is possible in accordance with another further development of the invention for the film to be heated up to the required orientation temperature of about 100 to 180° C. by means of heat radiators before the second orientation operation.

Temperature conditioning of the film is carried out after the orientation operation in accordance with another further development of the invention, with a temperature of 90 to 180° C. being reached in the film.

The conditions achieved in the film during orientation are set as a result.

It has also proved to be very advantageous if in accordance with another further development of the invention the film is cooled before winding.

In another advantageous further development of the invention, the film is siliconized on one or both sides.

The plastic film manufactured in this way can as a result be used very effectively as what is known as a release liner for many different applications.

The process is carried out in such a way that polypropylene is extruded from an annular die, with it being possible for several extruders to lead into this annular die. It is, however, also possible to provide further annular dies in a concentric arrangement with the first annular die. Further layers of the same or different plastics and tie layers etc. can be coextruded via the various extruders and/or annular dies.

Blends of PP with LLDPE or blends of PP with what are known as compatibilizers can be used instead of PP too. Polyamide can be used as the core layer as well.

The use of fillers for strength modification purposes is also possible. Fillers can in addition be added that increase the breathability of the film, particularly in connection with orientation.

Suitable polymers can be used in order to achieve advantageous bonding of a silicone layer.

It is possible in the coextrusion process to produce several layers simultaneously; seven layers have been coextruded at the same time in a preferred embodiment.

The extruded bubble is cooled to such a way that comparatively large film thicknesses are achieved in the blown film process. Film thicknesses of about 200μ can be produced in this context.

It is also provided that the dimensions of the bubble are determined by calibration. Both non-contact calibration and calibration by means of systems involving contact with the bubble are possible here.

In another further development of the invention, it is provided that an inner layer is supplied in finished form, to which the other layers are then applied by the coextrusion blown film process.

When it is still in bubble form, the film can be oriented after appropriate temperature conditioning, with it being possible for the orientation to be carried out transversely, i.e. in the circumferential direction, longitudinally or biaxially at the same time.

The film can then be collapsed and subjected to a further orientation operation after appropriate temperature conditioning.

In the simplest case, what is involved here is longitudinal orientation, which is carried out via a roller gap, for example. Transverse orientation, transverse and longitudinal orientation and simultaneous biaxial orientation are, however, possible.

Siliconization of one or both sides can be carried out inline too, with it being possible to use solvent-based, solvent-free, UV, electron beam curing or emulsion silicones as silicone systems.

The film manufactured in this way is suitable for use as a release liner, e.g. for labels and adhesive tapes or similar products, because of the very favorable properties.

The film can be used with excellent results as a substitute for release paper thanks to its high tear strength.

1.-11. (canceled)

12. Process for producing an oriented plastic film comprising at least one layer, each said layer being comprised of a polyolefin or a polyanide, comprising forming a film of one layer or of a plurality of layers by a blown film extrusion or coextrusion process, respectively, then, as a first orientation operation, biaxially orienting said film during said blown film extrusion or coextrusion process, and then subjecting said film to a second orientation operation.

13. Process according to claim 12, wherein the second orientation operation is carried out immediately after the first orientation operation.

14. Process according to claim 12, wherein the second orientation operation is carried out independently of the first orientation operation.

15. Process according to claim 12, wherein in the biaxial orientation, orientation with respect to both axes thereof is carried out simultaneously.

16. Process according to claim 12, wherein each of said orientation operations is carried out when the temperature of the film is 90 to 180° C.

17. Process according to claim 16, further comprising between the first and the second orientation operation, temperature conditioning the film by means of temperature conditioning rollers to hold the film at temperatures of about 100 to about 180° C.

18. Process according to claim 16, further comprising, between the first and the second orientation operations, heating the film to temperatures of about 100 to about 180° C. by means of heat radiators.

19. Process according to claim 12, further comprising temperature conditioning the film after the orientation operations by heating the film to temperatures of 90 to 180° C. thereby to set the orientation of the film.

20. Process according to claim 12, further comprising, after both orientation operations, cooling and then winding the film.

21. Process according to claim 12, further comprising siliconizing both sides of the film.

22. Process according to claim 12, wherein the film produced comprises a plurality of layers, the first layer is provided to the process as a finished film and additional layers are then applied to the first layer by the coextrusion film process.
